(19) United States
(12) Patent Application Publication
(10) Pub. No.: US 2014/0173420 A1
(43) Pub. Date: Jun. 19, 2014

(54) SMART OFFICE SYSTEM, OPERATION SERVER, AND OPERATION METHOD FOR THE SAME

(71) Applicant: Dae-Yong Jeong, Seoul (KR)

(72) Inventor: Dae-Yong Jeong, Seoul (KR)

(73) Assignee: KAONSOFT CO., LTD., Seongnam-si, Gyeonggi-do (KR)

(21) Appl. No.: 14/232,602

(22) PCT Filed: Aug. 22, 2012
(86) PCT No.: PCT/KR2012/006676

§ 371 Date: Jan. 13, 2014

(30) Foreign Application Priority Data
Aug. 23, 2011 (KR) 10-2011-0084115

(51) Int. Cl. G06F 17/24

(52) U.S. Cl. CPC G06F 17/248
USPC 715/234

(57) ABSTRACT

The present invention relates to smart office system, an operation server and a operation method for the same, which comprises: an office data server which processes data which is used in an office environment; a mobile terminal which processes view page-type data by using mobile network system; and a mobile web-server module which is interlocked with the office data server which responds to a request of the mobile terminal and has CDK for providing the mobile terminal with view pages which are related to the processed data.

### FIELD OF THE INVENTION

The present invention relates to smart office system, an operation server and operation method for the same for using enterprise environment.

### BACKGROUND ART

Recent change in telecommunication technologies has made adaptation of smart office system be essential in enterprise environment. Some companies have already implemented groupware and marketing procedure in mobile platform, or are implementing ERP and telematics in mobile platform. Further, some companies are preparing a standard system for mobilization of internal workflow in order to possibly adapt mobile office system.

Smart office system provides better communication without being interrupted by time and location. Further, smart office system provides improved productivity as well as value enhancement in office members and customers.

However, smart office system shall be qualified with some basic features for implementation, such as compatibility, economic feasibility, reliability, marketability, scalability and security.

That is, the smart office system shall support various operating systems (OS) and various types of devices. The smart office system shall provide better development efficiency, maintenance, function update and upgrade. Further, the smart office system shall provide reliability as well as securities in network and servers in order to support marketing management and payment in enterprise environment. Furthermore, the smart office system shall provide good features in view of adaptation, infrastructure of related technology, system interlocking, subsystem scalability and possible adaptation of new technologies.

### DISCLOSURE OF INVENTION

### Technical Problem

Currently, big System Integration (SI) companies are releasing smart office products. Those conventional products are based on hybrid-type of mobile applications, which renders the smart office system being dependent on devices, e.g., mobile phones or mobile taps. In general, although establishing a mobile office system with spending big cost, companies are further establishing an additional mobile office system in a light-weight mobile web environment.

Therefore, the present invention provides smart office system, an operation server and an operation method which provides better features of low cost, high efficiency, compatibility, stability, scalability, easy development, easy distribution, easy management and easy maintenance by utilizing a next-generation mobile web development framework with adapting web technologies having both merits of web and mobile environments.

### Technical Solution

According to the present invention, there is provided smart office system, which comprises: an office data server which processes data which is used in an enterprise environment; a mobile terminal which processes view page-type data by using mobile network system; and a mobile web-server module which is interlocked with the office data server which responds to a request of the mobile terminal and has CDK for providing the mobile terminal with view pages which are related to the processed data.

The present invention is characterized in that the office data server includes a groupware server, a mail server, an API server, a messenger server, a payment server, an ERP server, a CRM server and a DB server.

The present invention is characterized in that the mobile web-server module includes CDK for cloud development and connecters for connecting various data servers and service servers.

The present invention is characterized in that the mobile web-server module includes a server unit for providing interconnection to and data interlock with the office data server, CDK for providing various UI templates and design-related metadata, a control unit for controlling the server unit and the CDK, a metadata analysis unit, and a configuration unit for the adapters (connecters).

The present invention is characterized in that the server unit includes a connecter unit for providing interlock with legacy data, a smart-view engine unit for responding to page results which are optimized for various devices, operating systems and web-browsers such as android phones, i-phones, window phones, blackberry and Symbian, and CDK for generating the pages.

The present invention is characterized in that the connecter unit includes a SAP connecter for directly connecting to a SAP server, a SharePoint connecter for interlocking with functions of a SharePoint server, a DBMS connecter for interlocking with a DB server, and an XMLData connecter for processing business logics of a heterogeneous server.

The present invention is characterized in that the CDK includes a template manager for configuring and managing desktop browser, a metadata manager for providing data binding, a view-page manager for generating and editing view pages, a multi-lingual manager for configuring multi-language, a SAP manager for configuring SAP server information, and a DB encryption manager for providing encryption of database connection information.

Further, according to the present invention, there is provided an operation server for smart office system, comprising: a server unit for providing interconnection to and data interlock with the office data server, which including a connecter unit for providing interlock with legacy data, a smart-view engine unit for responding to page results which are optimized for various devices, operating systems and web-browsers such as android phones, i-phones, window phones, blackberry and Symbian, and CDK for generating the pages; and CDK for providing various UI templates and design-related metadata.

The present invention is characterized in that the operation server further comprises a control unit for controlling operation, metadata analysis unit, and configuration unit for the adapters (connecters).

Further, according to the present invention, there is provided an operation method for smart office system, comprising steps of: developing view pages by CDK of mobile web-server module; receiving a request for a view page from a user terminal; analyzing the request by the mobile web-server module so as to select an adapter which is connected to a data processing server corresponding to the request; providing the request to the data processing server through the adapter; completing the process by the data processing server so as to provide the processed data through the adapter; and providing the processed data in a view page type to the user terminal by the mobile web-server module.

The present invention is characterized in that the step of developing view pages includes steps of selecting a view template; configuring data mapping; determining data so as to modify view pages; and determining display of view page so as to distribute the view pages.

### Advantageous Effects

According to the present invention, there may be provided a system which provides better features of low cost, high efficiency, compatibility, stability, scalability, easy development, easy distribution, easy management and easy maintenance by utilizing a next-generation mobile web development framework with adapting web technologies having both merits of web and mobile environments.

Further, the interface between data servers (i.e., service servers) and applications in terminal devices may be standardized, and the efficiency of development and software reuse may be maximized.

Further, pages may be perfectly generated by the procedures of selecting templates corresponding to a wished view, editing contents of pages, providing preview with mapping data to bind and confirming pages before saving. Furthermore, views may be edited at any time after saving so as to let pages to be added or modified.

Further, various UI templates and metadata may be available by CDK, which renders the generation and maintenance of UI being easily achieved. Furthermore, coding may be unnecessary, which renders server development being quick and server operation becoming stable.

### BRIEF DESCRIPTION OF THE DRAWINGS

FIG. 1 is a conceptual diagram of smart office system according to an embodiment of the present invention.

FIG. 2 is a conceptual diagram of a mobile web-server module according to an embodiment of the present invention.

FIG. 3 is an example of a block diagram of a mobile web-server module.

FIG. 4 is an example of a block diagram of a server unit.

FIG. 5 shows smart office system according to an embodiment of the present invention.

FIG. 6 is a flowchart of operation method of smart office system according to an embodiment of the present invention.

FIG. 7 is an example of operation display of CDK.

FIG. 8 shows an example of operation of CDK.

FIG. 9 is a flowchart of view generation method of CDK according to an embodiment of the present invention.

FIGS. 10 to 12 are operation displays of smart office system according to an embodiment of the present invention.

### EMBODIMENTS FOR CARRYING OUT THE INVENTION

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals shall be used in referring to like parts throughout the various figures and embodiments of the present invention.

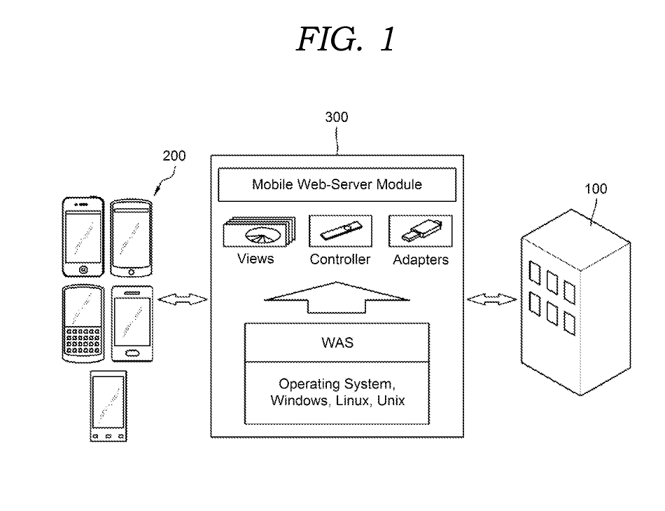

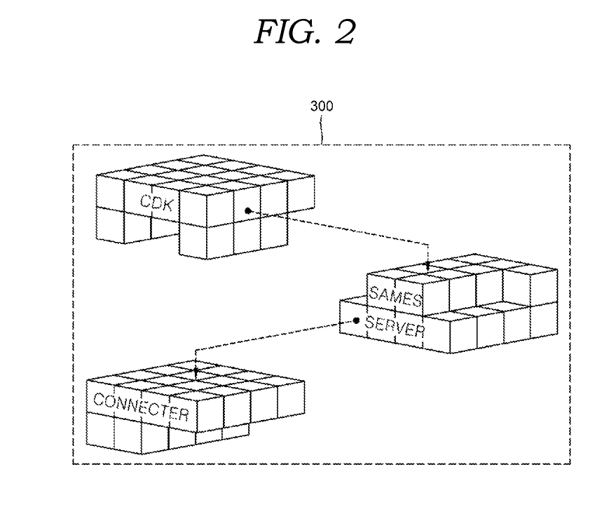

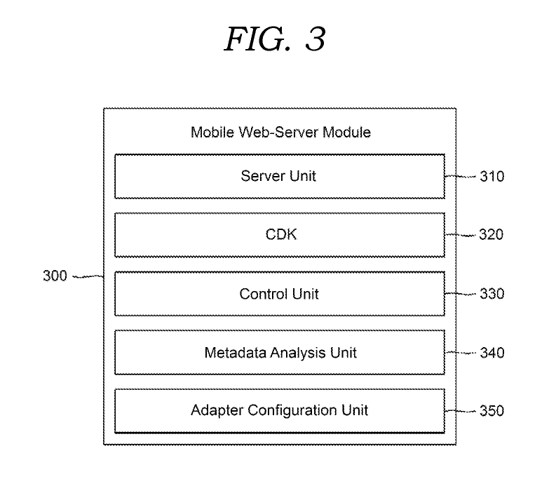

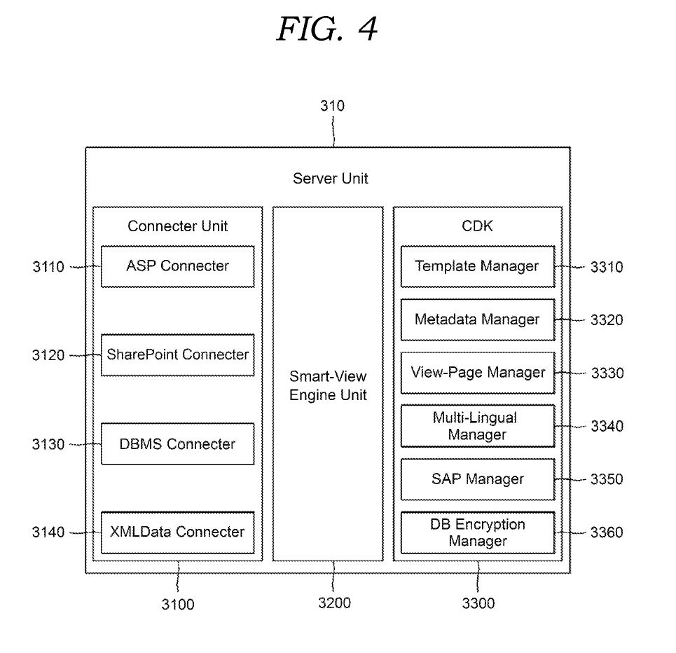

FIG. 1 is a conceptual diagram of smart office system according to an embodiment of the present invention. FIG. 2 is a conceptual diagram of a mobile web-server module according to an embodiment of the present invention. FIG. 3 is a block diagram of a mobile web-server module according to an embodiment of the present invention. FIG. 4 is a block diagram of a server unit according to an embodiment of the present invention.

Referring to FIGS. 1 to 4, the smart office system of this embodiment comprises an office data server 100 which processes data that is used in an office environment, mobile terminals 200 which process view page-type data by using mobile network system, and a mobile web-server module 300 which is interlocked with the office data server 100 which responds to requests of the mobile terminals 200 and provides the mobile terminals 200 with view pages which are related to the processed data.

The office data server 100 includes various types of servers which are used in enterprise environment for data management and member communication. The office data server 100 includes groupware server, mail server, API server, messenger server, payment server, ERP server, CRM server and DB server. The office data server 100 is not restricted to the above, but may includes various types of servers, modules or programs that may execute the operations. The office data server 100 has various operation systems, internal programs and unique data processing according to operation features.

The mobile terminals 200 are used in order for users (i.e., office members) to generate or edit data of office data servers as necessary. The mobile terminals 200 are provided with standard interfaces of view page.

These mobile terminals 200 may includes various kinds of devices, operating systems and web-browsers such as android phones, i-phones, window phones, blackberry and Symbian.

The mobile web-server module 300 in this embodiment is a framework for developing next-generation mobile web applications with maintaining both merits of web and mobile, by which the shortage of prior-art hybrid applications may be compensated. The mobile web-server module 300 standardizes interfaces between applications in terminals and data servers (i.e., service servers), and may improve the efficiency of application development and software reuse.

The mobile web-server module 300 includes CDK (Cloud Development Kit) for cloud development as well as connecters for connections to various data servers and service servers, as shown in FIG. 2. The mobile web-server module 300 further includes SAMES (Softobject Astandard Mobile Enterprise Solution) server unit for controlling the CDK and connecters and for interlocking the data between the CDK and connecters. The mobile web-server module 300 may be configured in various types. For example, a connecter may be included inside of the server unit, or a part of the CDK may be included in the server unit, which means that the units may operate independently or operate by an operation system.

In this embodiment, the mobile web-server module 300 may further includes a server unit 310 for providing interconnection to and data interlock with the office data server 100, a control unit 330 for providing various UI templates and control functions, a metadata analysis unit 340, and a configuration unit 350 for the adapters (connecters), as shown in FIG. 3.

The server unit 310 includes a connecter unit 3100, a smart-view engine unit 3200 and CDK 3300.

The connecter unit 3100 may easily connect to legacy systems (SAP, ERP, CRM, etc.) and provides interlocking with the legacy data of the company. That is, the connecter unit 3100 includes various connecters for interconnecting to the office data servers 100.

The connecter unit 3100 includes a SAP connecter 3110 for directly connecting to a SAP server, a SharePoint connecter 3120 for interlocking with functions of a SharePoint server, a DBMS connecter 3130 for interlocking with a DB server, and an XMLData connecter 3140 for processing business logics of heterogeneous servers. Although unshown, the connecter unit 3100 may further include various connecters for interconnecting to legacy system. Further, the connecter unit 3100 may further include modules for data conversion.

In this embodiment, the connecter unit 3100 may provide various connecter interconnections to a single server. For example, various connecter interconnections may be available to a mail service, which means that connecter mapping may be changed without changing applications or mail MBS.

The smart-view engine unit 3200 is designed to respond to page results which are optimized for various devices, operating systems and web-browsers such as android phones, i-phones, window phones, blackberry and Symbian. Further, the smart-view engine unit 3200 sends the views (i.e., web pages) to each terminal, which displays the views by standard interface.

The CDK 3300 includes a template manager 3310 for configuring and managing desktop browser, a metadata manager 3320 for providing data binding, a view-page manager 3330 for generating and editing view pages, a multi-lingual manager 3340 for configuring multi-language, a SAP manager 3350 for configuring SAP server information, and a Database (DB) encryption manager 3360 for providing encryption of database connection information.

The CDK 3300 provides functions which enables an office worker to easily generate screens as a design. That is, the CDK 3300 provides functions of selecting a template for each pattern, designing screens, binding database and configuring attributes so as to distribute pages to servers.

When the CDK 3300 is installed in a server, the CDK 3300 provides screens for managing the server. The screens of CDK 3300 may include coding box, design toolbox, UI templates, and preview, etc.

Therefore, the template manager 3310 of CDK 3300 may register and manage various templates, e.g., login, list, form, detail view, and chart.

The view-page manager 3330 provides functions of selecting a template corresponding to a wished view, editing contents of pages, providing preview by mapping data to bind and confirming pages before saving so as to generate perfect pages. The views may be edited at any time after saving so as to let pages to be added or modified.

The metadata manager 3320 may modify mapping information which has been made during generation of view pages or may generate a new mapping information so as to generate screens such as a chart, etc.

The multi-lingual manager 3340 may configure the adoption of multi-language according to the language setting of devices.

The SAP manager 3350 may provide the data interlocking with a SAP server by configuring interlock information of the SAP server.

The DB encryption manager 3360 provides encryption of database connection information so as to secure the connection.

In this embodiment a self-developed CDK 3300 is provided. By the self-development, various UI templates and metadata are available, which renders generation and maintenance of UI being easily achieved. Further, because coding is unnecessary, server development is quick and server operation is stable.

The method of operating the smart office system shall be described below with referring to figures.

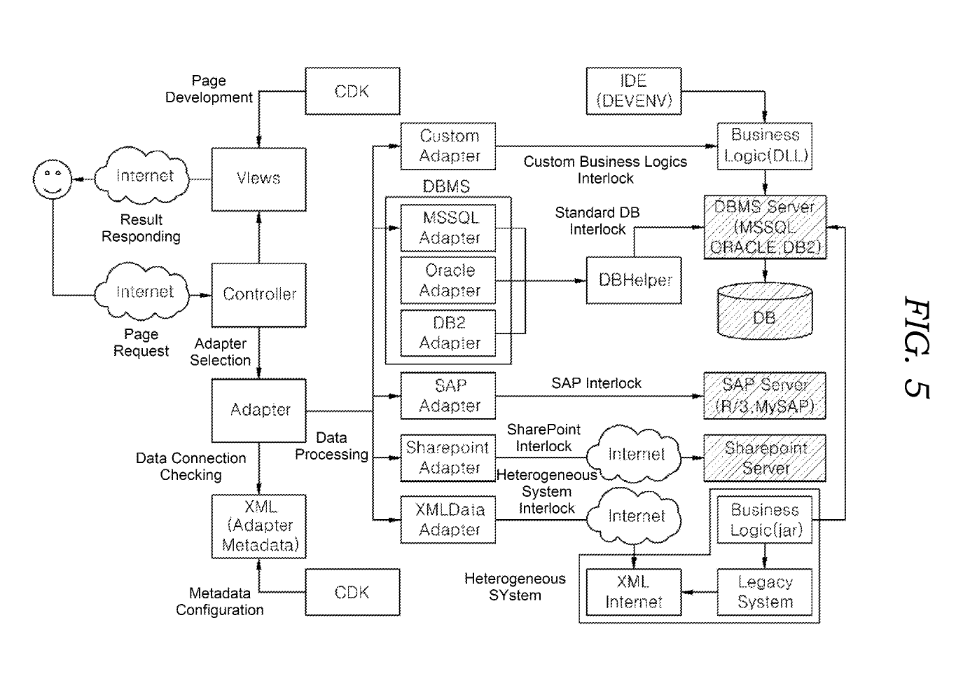

FIG. 5 shows smart office system according to an embodiment of the present invention.

First, the mobile web-server module 300 develops view pages by CDK, as shown in FIG. 5.

Then, a user requests a target view page through mobile network. The controller of the mobile web-server module selects an adapter (i.e., connecter) corresponding to the request. The data processing is performed by the selected adapter. That is, one of adapters, e.g., Custom adapter, DBMS adapter (i.e., MSSQL adapter, Oracle adapter, DB2 adapter), SAP adapter, SharePoint adapter, XMLData adapter, is selected, by which the data processing is performed. In this stage, by metadata configuration of CDK, a pre-arranged XML adapter metadata may be used.

The controller of the server provides the processed data to user terminals through view pages.

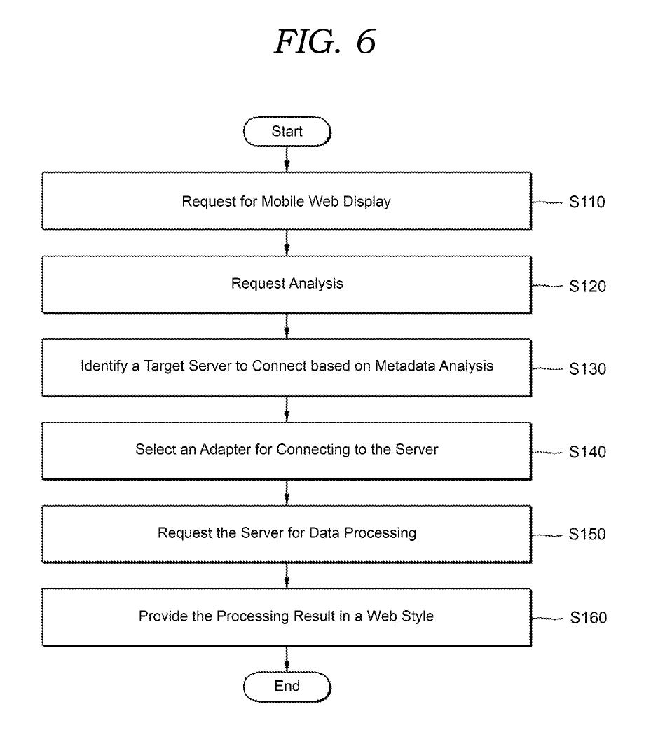

FIG. 6 is a flowchart of operation method of smart office system according to an embodiment of the present invention.

As shown in FIG. 6, the mobile web-server module 300 receives a request from user terminals, e.g. smart phones (S110).

Then, the controller of the mobile web-server module 300 analyzes the request upon web display. In this stage, the controller may analyze an entered URL or analyze data of the request data (S120). The controller may select an adapter through the analyzed service name.

Then, the controller identifies a target server to connect by metadata analysis, and then confirms data processing information (S130).

Then, the controller generates or selects an adapter for connecting the identified target server, and then connects the target server (S140).

Then, the controller sends parameters to the target server so as to perform the data processing (S150).

Then, the controller provides the result to the user terminals in web-page style by generating view pages (S160).

The present invention may be adapted to various terminals by generating view pages through CDK and developing interfaces in a standard form in this embodiment. Through multi-platform structure, native applications utilizing device resources may be combined to web environment. Further, JavaScript, HTML5 and CSS3 may be utilized instead of Java or Object-C. Further, the connection to office data servers may be easily achieved by utilizing connecters.

The mobile web-server module 300 of this embodiment may provide SDK and CDK. Further, the mobile web-server module 300 of this embodiment may provide more enhanced mobile integrated solution through a constitution of SharePoint, control boxes, smart viewer, multi-adapter, IIS and Window Server.

By providing a separately-developed CDK, generation and maintenance of UI are easily achieved. Further, because coding for each case is unnecessary, server development is quick and server operation is stable.

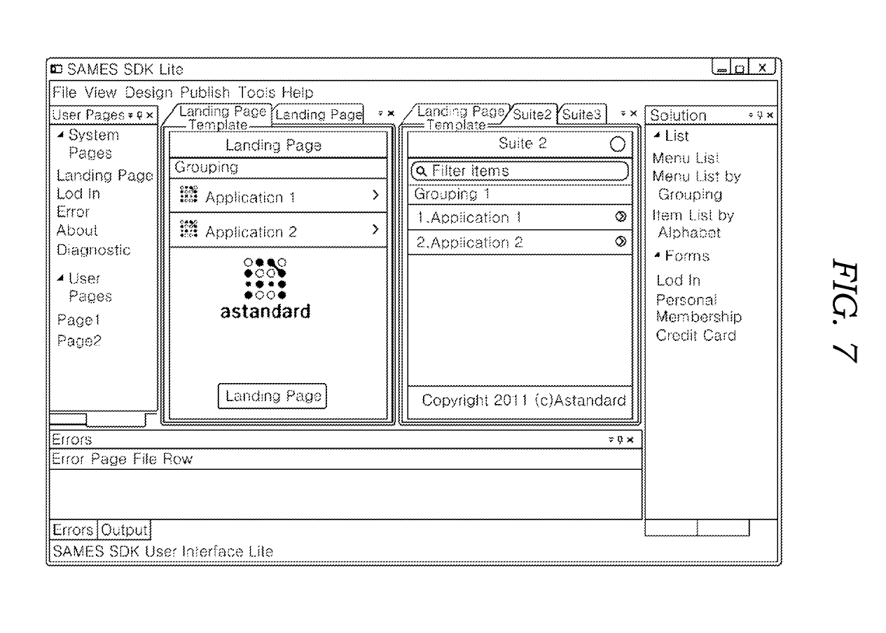

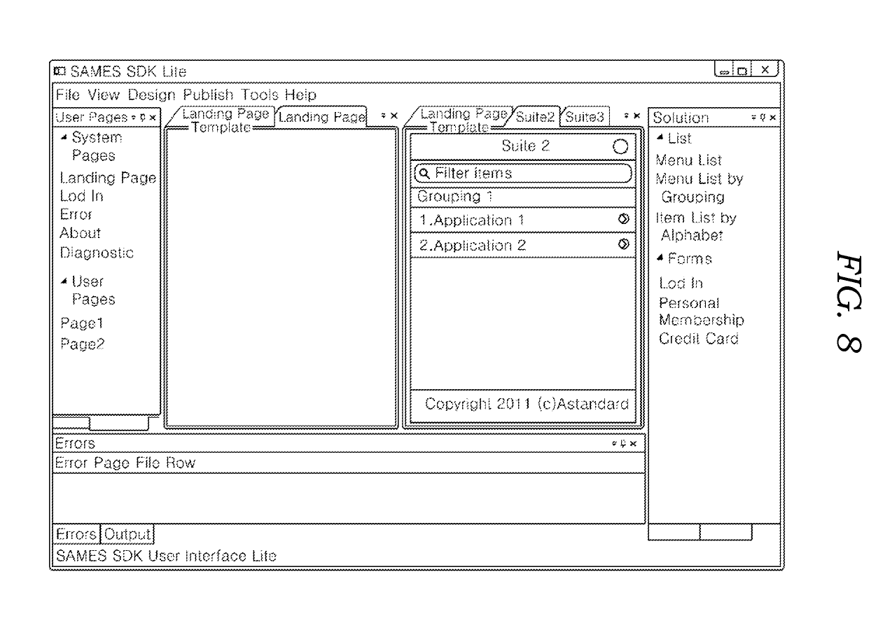

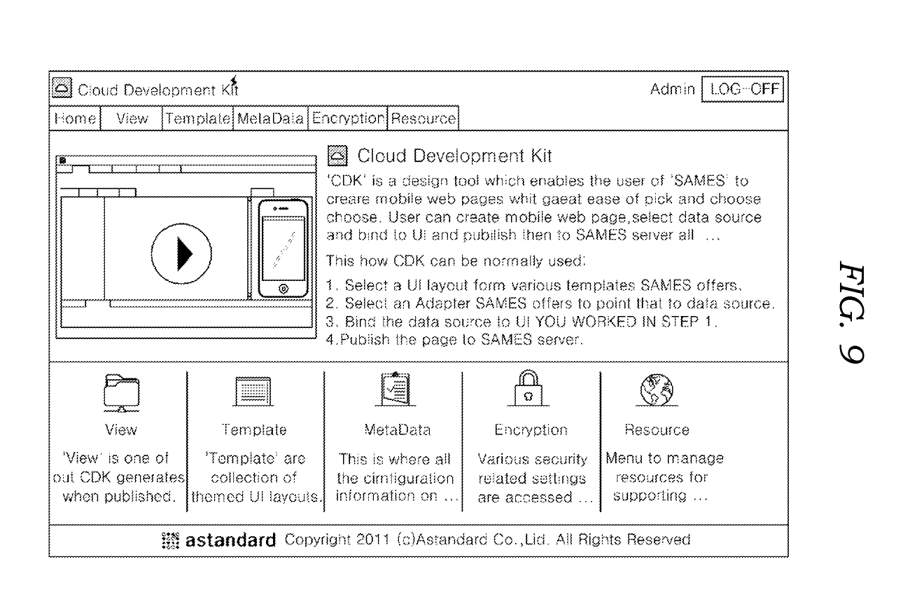

FIG. 7 is an example of operation display of CDK. FIG. 8 shows an example of operation of CDK, and FIG. 9 is a flowchart of view generation method of CDK according to an embodiment of the present invention.

As shown in FIGS. 7 and 8, the CDK selects a page template and modifies page contents. Then, the CDK configures data mapping, generates preview of the pages, and then distribute the pages.

Further, the CDK selects a view template (S210) as shown in FIG. 9.

Then, the CDK configures data mapping in which service name, page name and data matching information are configured (S220).

Then, the CDK checks whether the data processing is appropriate (S230). If the answer is ‘NO’, the data mapping is reconfigured. Otherwise, the view is modified (S240).

Then, the CDK checks whether the page display is appropriate (S250). If the answer is ‘NO’, the appropriateness of data processing is re-checked. Otherwise, the view is distributed (S260). It is preferable that the route of servers for the distribution shall be configured.

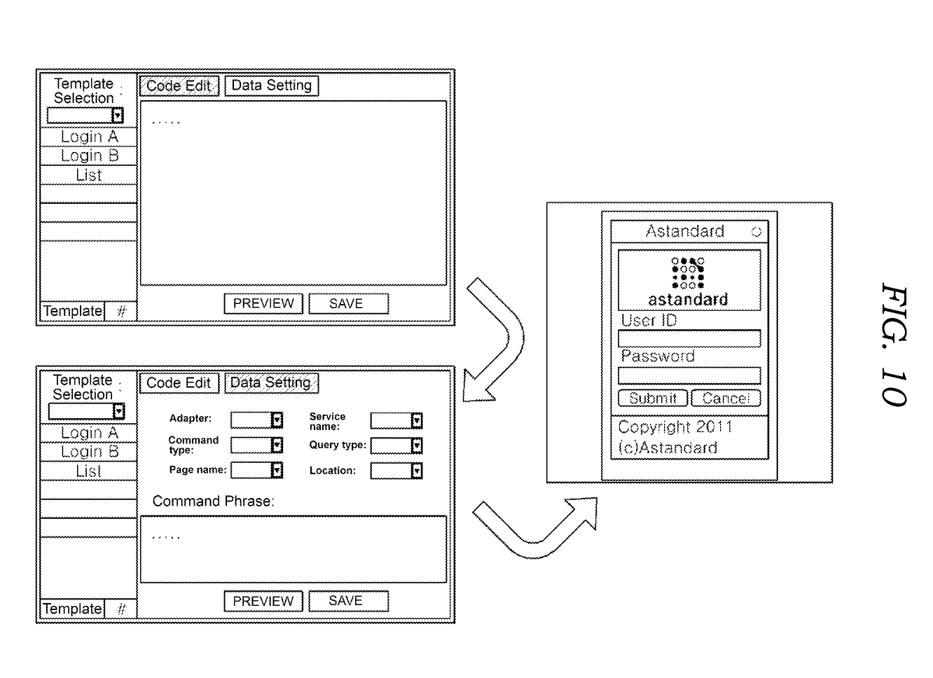

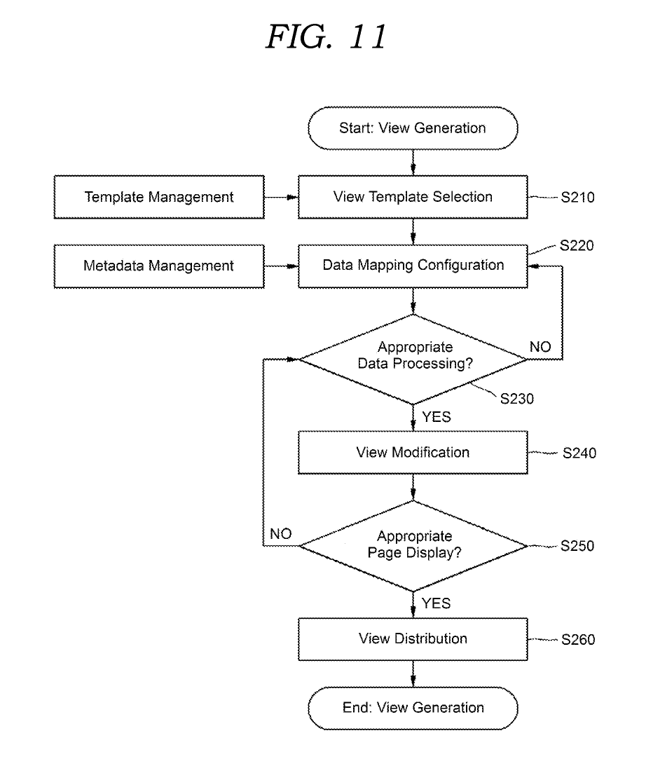

FIGS. 10 and 11 are operation displays of smart office system according to an embodiment of the present invention.

With referring to FIG. 10, after completing login, un-approval list is retrieved and an item is selected to approve. Then, approval or return is processed for the selected item, by which the corresponding reporter may receive an e-mail for the approval or return.

With referring to FIG. 11, after completing login, there may be provided functions such as work menu selection, search condition setting, result checking and detail inquiry.

The preferred embodiment of the present invention has been described above. However, the preferred embodiment has been set forth for the purpose of describing the present invention, not for limiting the scope of the present invention. Those skilled in the art may understand that various embodiments may be available without departure from the spirit and scope of the present invention.

1. Smart office system, comprising:
an office data server which processes data which is used in an office environment;
a mobile terminal which processes view page-type data by using mobile network system; and
a mobile web-server module which is interlocked with the office data server which responds to a request of the mobile terminal and has CDK for providing the mobile terminal with view pages which are related to the processed data.

2. The smart office system according to claim 1, wherein the office data server includes a groupware server, a mail server, an API server, a messenger server, a payment server, an ERP server, a CRM server and a DB server.

3. The smart office system according to claim 1, wherein the mobile web-server module includes CDK for cloud development and connecters for connecting various data servers and service servers.

4. The smart office system according to claim 1, wherein the mobile web-server module includes a server unit for providing interconnection to and data interlock with the office data server, CDK for providing various UI templates and design-related metadata, a control unit for controlling the server unit and the CDK, a metadata analysis unit, and a configuration unit for the adapters (connecters).

5. The smart office system according to claim 4, wherein the server unit includes a connecter unit for providing interlock with legacy data, a smart-view engine unit for responding to page results which are optimized for various devices, operating systems and web-browsers, and CDK for generating the pages.

6. The smart office system according to claim 5, wherein the connecter unit includes a SAP connecter for directly connecting to a SAP server, a SharePoint connecter for interlocking with functions of a SharePoint server, a DBMS connecter for interlocking with a DB server, and an XMLData connecter for processing business logics of a heterogeneous server.

7. The smart office system according to claim 5, wherein the CDK includes a template manager for configuring and managing desktop browser, a metadata manager for providing data binding, a view-page manager for generating and editing view pages, a multi-lingual manager for configuring multi-language, a SAP manager for configuring SAP server information, and a DB encryption manager for providing encryption of database connection information.

8. An operation server for smart office system, comprising:
a server unit for providing interconnection to and data interlock with the office data server, which including a connecter unit for providing interlock with legacy data, a smart-view engine unit for responding to page results which are optimized for various devices, operating systems and web-browsers, and CDK for generating the pages;
a control unit for controlling operation, metadata analysis unit, and configuration unit for the adapters (connecters).

9. The operation server for smart office system according to claim 8, wherein the connecter unit includes a SAP connecter for directly connecting to a SAP server, a SharePoint connecter for interlocking with functions of a SharePoint server, a DBMS connecter for interlocking with a DB server, and an XMLData connecter for processing business logics of a heterogeneous server.

10. The operation server for smart office system according to claim 8, wherein the CDK includes a template manager for configuring and managing desktop browser, a metadata manager for providing data binding, a view-page manager for generating and editing view pages, a multi-lingual manager for configuring multi-language, a SAP manager for configuring SAP server information, and a DB encryption manager for providing encryption of database connection information.

11. An operation method for smart office system, comprising steps of:
developing view pages by CDK of mobile web-server module;
receiving a request for a view page from a user terminal;
analyzing the request by the mobile web-server module so as to select an adapter which is connected to a data processing server corresponding to the request;
providing the request to the data processing server through the adapter;
completing the process by the data processing server so as to provide the processed data through the adapter; and
providing the processed data in a view page type to the user terminal by the mobile web-server module,
and wherein the step of developing view pages includes steps of selecting a view template; configuring data mapping; determining data so as to modify view pages; and determining display of view page so as to distribute the view pages.
